(19) United States
(12) Patent Application Publication
(10) Pub. No.: US 2009/0154308 A1
(43) Pub. Date: Jun. 18, 2009

(54) OPTICAL DISC APPARATUS, GAIN SETTING METHOD AND PROGRAM

(75) Inventor: Hideo KATO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/328,179

(22) Filed: Dec. 4, 2008

(30) Foreign Application Priority Data
Dec. 17, 2007 (JP) 2007-325223

(51) Int. Cl. G11B 7/00

(52) U.S. Cl. 369/44.29; G9B/7

(57) ABSTRACT

There is provided an optical disc apparatus that includes a sound pickup portion, an optical pickup to record a sound picked up by the sound pickup portion as audio data onto an optical disc using laser light, a focus adjustment portion to adjust a focal position of the laser light based on the focus drive signal, a tracking control portion to control tracking so that the optical pickup traces a track formed on the optical disc, and a gain setting portion to change the gain of the focus drive signal during a first period when adjustment of the focal position of the laser light by the focus adjustment portion is performed and control by the tracking control portion is not performed according to a level of an operation sound of the focus adjustment portion.

### CROSS REFERENCES TO RELATED APPLICATIONS

The present invention contains subject matter related to Japanese Patent Application JP 2007-325223 filed in the Japan Patent Office on Dec. 11, 2007, the entire contents of which being incorporated herein by reference.

### BACKGROUND OF THE INVENTION

1. Field of the Invention

The present invention relates to an optical disc apparatus, a gain setting method and a program.

2. Description of the Related Art

An optical disc apparatus capable of recording various kinds of data such as video data and audio data on an optical disc is widespread today. When recording or playing back data, the optical disc apparatus performs focus servo by applying laser light from an optical pickup onto an optical disc and moving the optical pickup based on a focus error signal from the optical disc to adjust the focus position of laser light. After that, the optical disc apparatus performs tracking servo in the same manner based on a tracking error signal from the optical disc so that the laser light traces the track of the optical disc. In the state where the focus servo and the tracking servo are performed, the optical disc apparatus can record data onto the optical disc or play back data recorded on the optical disc.

The optical disc apparatus is increasingly used not only in a home video recorder and a PC (Personal Computer) but also in portable imaging equipment, in which a magnetic tape such as a DV (Digital Video) tape has been used. The portable imaging equipment capable of recording motion video data onto an optical disc has a higher user-friendliness than portable imaging equipment of a previously known type, for its high random access capability, capability to playback recorded motion video promptly and capability to transfer and edit data easily.

However, in the portable imaging equipment that includes the optical disc apparatus, the operation sound of the optical pickup that occurs during the period when the focus servo is performed and the tracking servo is not performed is recognized as an issue in some cases. The operation sound is generated because a tracking error signal when the tracking servo is not performed leaks into a focus error signal and the optical pickup operates in response to the leakage signal.

Thus, the portable imaging equipment that includes the optical disc apparatus may undesirably record such an operation sound, besides a sound to be picked up and recorded, onto an optical disc, and therefore a technique to address such an issue has been studied. For example, Japanese Unexamined Patent Application Publication No. 59-135644 discloses the optical disc apparatus that generates a focus drive signal for adjusting a focal position by reducing a gain with respect to a focus error signal to a previously set value during the period when the focus servo is performed and the tracking servo is not performed.

### SUMMARY OF THE INVENTION

However, because the level of the operation sound recorded on an optical disc is affected by a distance between a microphone and the optical pickup, the characteristics of the optical pickup, a variation in the chucking of the optical disc and so on, it is difficult to previously set the gain of the focus drive signal with respect to the focus error signal to an appropriate value. Further, excessive reduction of the gain of the focus drive signal with respect to the focus error signal causes degradation in the stability of the focus servo.

In light of the foregoing, it is desirable to provide a novel and improved optical disc apparatus, a gain setting method and a program capable of dynamically setting the gain of the focus drive signal with respect to the focus error signal.

According to an embodiment of the present invention, there is provided an optical disc apparatus that includes a sound pickup portion, an optical pickup to record a sound picked up by the sound pickup portion as audio data onto an optical disc using laser light, a signal generation portion to generate a focus drive signal having a designated gain with respect to a focus error signal, a focus adjustment portion to adjust a focal position of the laser light based on the focus drive signal generated by the signal generation portion, a tracking control portion to control tracking so that the optical pickup traces a track formed on the optical disc, an operation sound extraction portion to extract an operation sound of the focus adjustment portion from the sound picked up by the sound pickup portion, and a gain setting portion to change the gain of the focus drive signal during a first period when adjustment of the focal position of the laser light by the focus adjustment portion is performed and control by the tracking control portion is not performed according to a level of the operation sound extracted by the operation sound extraction portion.

In this configuration, the gain setting portion changes the gain of the focus drive signal during the first period according to the actual level of the operation sound of the focus adjustment portion extracted by the operation sound extraction portion. Thus, the optical disc apparatus can set the gain of the focus drive signal during the first period not previously but dynamically according to the actual operation sound level of the focus adjustment portion.

The gain setting portion may set the gain of the focus drive signal during the first period to a gain lower than a gain during a second period when adjustment of the focal position of the laser light by the focus adjustment portion is performed and control by the tracking control portion is performed. The operation sound level is expected to be higher as the gain of the focus drive signal is larger and to be lower as the gain of the focus drive signal is smaller. Thus, by setting the gain of the focus drive signal during the first period to a gain lower than a gain during the second period, it is possible to suppress the operation sound recorded onto the optical disc during the first period.

The gain setting portion may set the gain of the focus drive signal during the first period to a gain causing the operation sound to become equal to or lower than a prescribed level. In this configuration, it is possible to limit the level of the operation period recorded onto the optical disc to be equal to or lower than a prescribed level. Further, the gain setting portion may reduce the gain of the focus drive signal during the first period until the operation sound becomes equal to or lower than a prescribed level.

The gain setting portion may change the gain of the focus drive signal according to the level of the operation sound only when sound pickup by the sound pickup portion is performed during the first period. In this configuration, it is possible to prevent degradation of the stability of focus servo due to unnecessary reduction of the gain of the focus drive signal while sound pickup by the sound pickup portion is not performed.

The optical disc apparatus may further include a memory to temporarily store the sound picked up by the sound pickup portion as audio data, and the optical pickup may intermittently record the audio data temporarily stored in the memory onto the optical disc using the laser light, and control by the tracking control portion may be started after adjustment of the focal position of the laser light by the focus adjustment portion is started, and recording of the audio data onto the optical disc by the optical pickup may be started after control by the tracking control portion is started.

According to another embodiment of the present invention, there is provided a program causing a computer installed in an optical disc apparatus including a sound pickup portion, an optical pickup to record a sound picked up by the sound pickup portion as audio data onto an optical disc using laser light, a signal generation portion to generate a focus drive signal having a designated gain with respect to a focus error signal, a focus adjustment portion to adjust a focal position of the laser light based on the focus drive signal generated by the signal generation portion, and a tracking control portion to control tracking so that the optical pickup traces a track formed on the optical disc to implement functions including an operation sound extraction portion to extract an operation sound of the focus adjustment portion from the sound picked up by the sound pickup portion, and a gain setting portion to change the gain of the focus drive signal during a first period when adjustment of the focal position of the laser light by the focus adjustment portion is performed and control by the tracking control portion is not performed according to a level of the operation sound extracted by the operation sound extraction portion.

The above program can cause a computer hardware resource that includes CPU, ROM, RAM or the like to execute the functions of the operation sound extraction portion and the gain setting portion described above. It is thereby possible to allow a computer that implements the program to function as the above-described operation sound extraction portion and the gain setting portion.

According to another embodiment of the present invention, there is provided a gain setting method executed in an optical disc apparatus including a sound pickup portion, an optical pickup to record a sound picked up by the sound pickup portion as audio data onto an optical disc using laser light, a signal generation portion to generate a focus drive signal having a designated gain with respect to a focus error signal, a focus adjustment portion to adjust a focal position of the laser light based on the focus drive signal generated by the signal generation portion, and a tracking control portion to control tracking so that the optical pickup traces a track formed on the optical disc, the method including the steps of extracting an operation sound of the focus adjustment portion from the sound picked up by the sound pickup portion, and changing the gain of the focus drive signal during a first period when adjustment of the focal position of the laser light by the focus adjustment portion is performed and control by the tracking control portion is not performed according to a level of the operation sound.

According to the embodiments of the present invention described above, it is possible to dynamically set the gain of the focus drive signal with respect to the focus error signal.

### BRIEF DESCRIPTION OF THE DRAWINGS

FIG. 1 is an explanatory view showing the appearance of an optical disc apparatus 20 according to an embodiment.

FIG. 2 is a functional block diagram showing the configuration of an optical disc apparatus 21 according to a related art.

FIG. 3 is an explanatory view showing the relationship among a focus drive signal, a focus error signal and a tracking error signal during a first period.

FIG. 4 is an explanatory view showing the relationship among a focus drive signal, a focus error signal and a tracking error signal during a second period.

FIG. 5 is a functional block diagram showing the configuration of an optical disc apparatus 20 according to an embodiment.

FIG. 6 is an explanatory view showing the configuration of an optical pickup 210.

FIG. 7 is an explanatory view showing the state of each function at the start of recording video data and audio data.

FIG. 8 is an explanatory view showing a change in focus gain during the first period.

FIG. 9 is a flowchart showing the flow of a gain setting method executed in the optical disc apparatus 20.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described in the following order:

(1) Outline of the optical disc apparatus according to an embodiment

(2) Circumstances of development of an embodiment

(3) Functions of the optical disc apparatus according to an embodiment

(4) Operation of the optical disc apparatus according to an embodiment

(5) Summary

### (1) Outline of the Optical Disc Apparatus According to an Embodiment

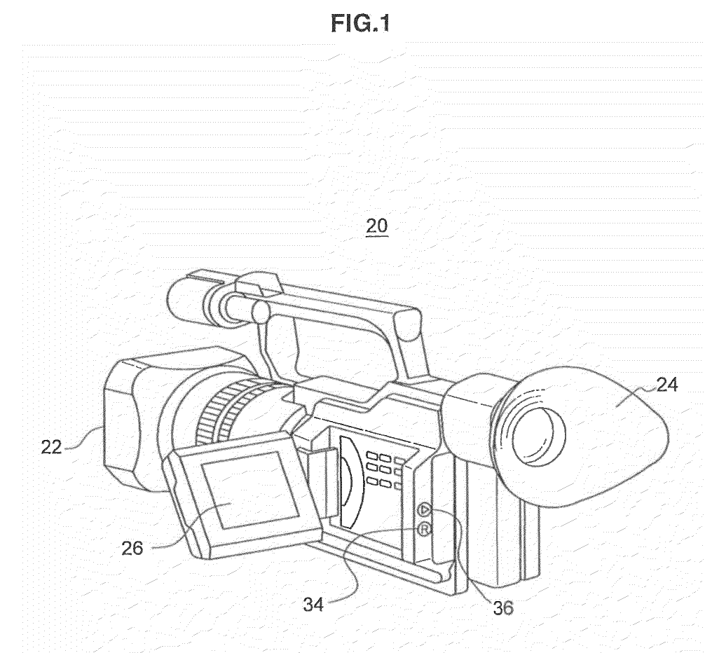

The configuration of an optical disc apparatus 20 according to an embodiment is schematically described hereinafter with reference to FIG. 1.

FIG. 1 is an explanatory view showing the appearance of the optical disc apparatus 20 according to an embodiment. Referring to FIG. 1, the optical disc apparatus 20 includes a lens portion 22, a viewfinder 24, a display portion 26, a recording button 34 and a playback button 36.

The lens portion 22 collects light emitted from a subject and forms the image of the subject on an appropriate position within the optical disc apparatus 20. The video of the subject is shown in the viewfinder 24, and a user can adjust the direction that the lens portion 22 faces while checking the video shown in the viewfinder 24.

The display portion 26 has a function as a display portion that displays a video. For example, the display portion 26 can display the video of the subject whose light is currently collected by the lens portion 22 or the video already recorded in the past.

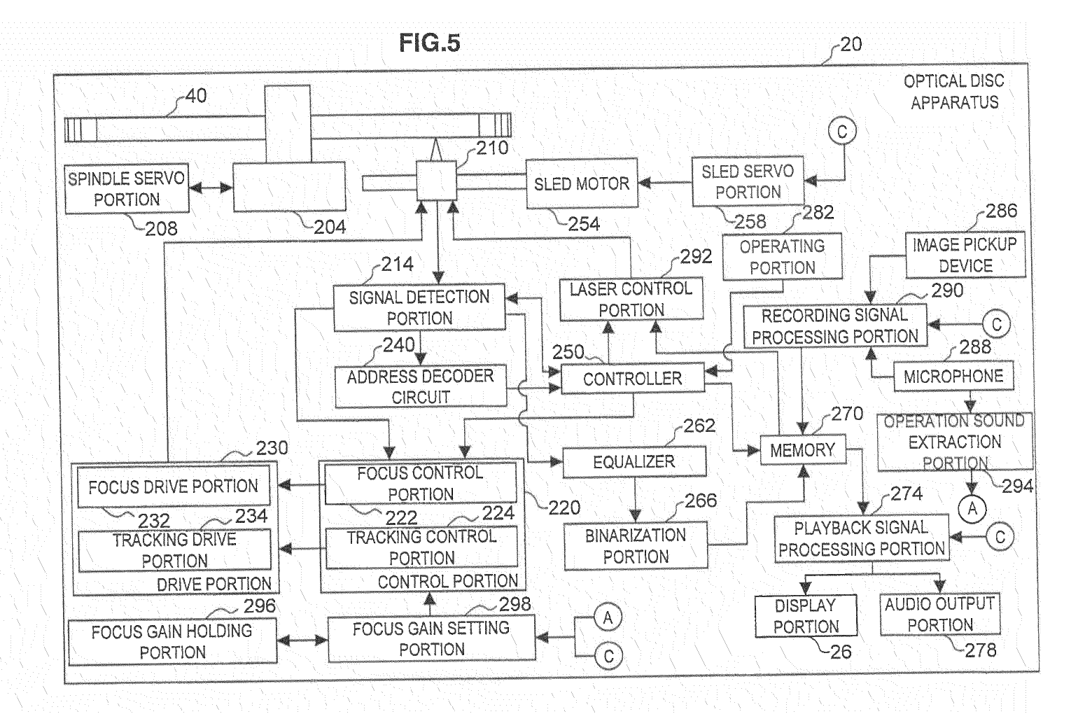

The recording button 34 detects user operation that directs the start of recording of data such as videos and sounds onto an optical disc (which is denoted by the numeral 40 in FIG. 5) by the optical disc apparatus 20. Further, a user can direct the pause of data recording by pressing the recording button 34 during data recording. If processing different from the direction for the start of data recording is requested during the pause of data recording, the standby state for subsequent data recording is released. In other words, the pause is released.

The playback button 36 detects user operation that directs the start of playback of data such as videos and sounds recorded on the optical disc included in the optical disc apparatus 20. Further, a user can direct the pause of data playback by pressing the playback button 36 during data playback.

FIG. 1 shows portable imaging equipment merely as an example of the optical disc apparatus 20, and the optical disc apparatus 20 is not limited to portable imaging equipment. For example, the optical disc apparatus 20 may be information processing devices such as a PC (Personal Computer), a home video processing device (e.g. a DVD recorder, a videocassette recorder etc.), a cellular phone, a PHS (Personal Handyphone System), a portable music playback device, a portable video processing device, a PDA (Personal Digital Assistants), home game equipment, portable game equipment and an electrical household appliance.

### (2) Circumstances of Development of an Embodiment

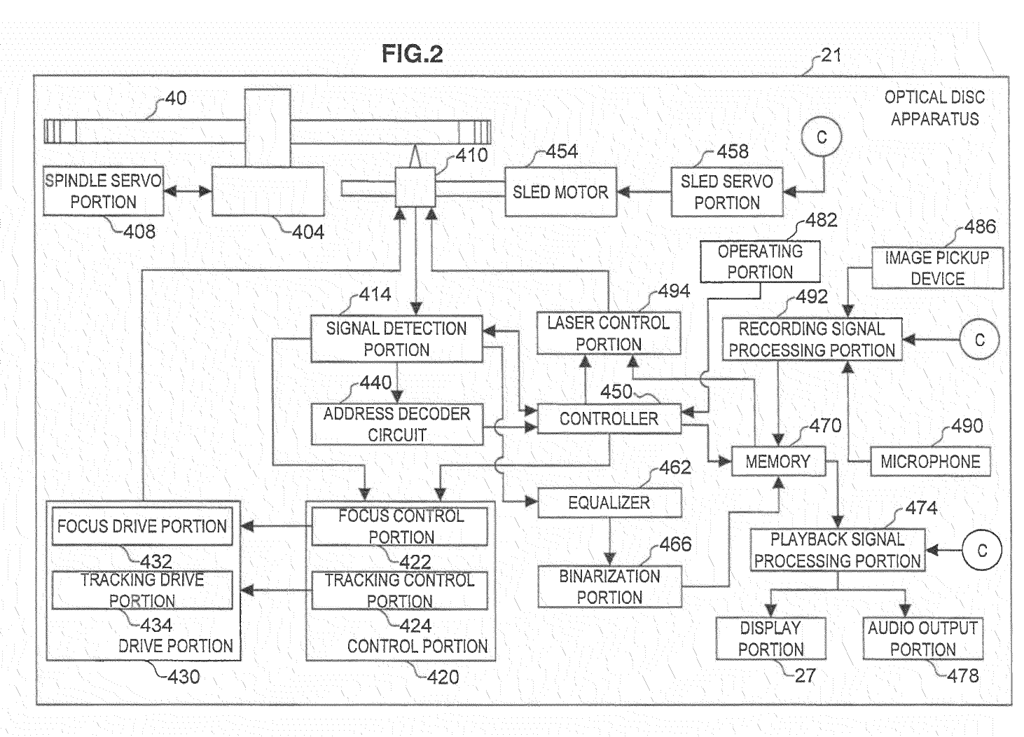

The optical disc apparatus 20 according to an embodiment is schematically described with reference to FIG. 1 in the foregoing. In the following, the circumstances that the optical disc apparatus 20 according to an embodiment has been invented are described with reference to FIGS. 2 to 4.

FIG. 2 is a functional block diagram showing the configuration of an optical disc apparatus 21 according to a related art. Referring to FIG. 2, the optical disc apparatus 21 of the related art includes a spindle motor 404, a spindle servo portion 408, an optical pickup 410, a signal detection portion 414, a control portion 420, a drive portion 430, an address decoder circuit 440, a controller 450, a sled motor 454, a sled servo portion 458, an equalizer 462, a binarization portion 466, a memory 470, a playback signal processing portion 474, an audio output portion 478, an operating portion 482, an image pickup device 486, a microphone 490, a recording signal processing portion 492, a laser control portion 494, and a display portion 27.

### (Operation in the Recording Mode)

In the optical disc apparatus 21 according to a related art, in the recording mode, video data of a subject image captured by the image pickup device 486 and audio data of an external sound captured by the microphone 490 are input to the recording signal processing portion 492. The recording signal processing portion 492 converts the input video data and audio data into data in a format recordable on the optical disc 40. Then, the data converted by the recording signal processing portion 492 is temporarily stored in the memory 470. If the amount of data stored in the memory 470 exceeds a prescribed amount, the video data and the audio data are read from the memory 470 by the controller 450 and transmitted to the laser control portion 494.

Further, the controller 450 causes the spindle servo portion 408 to drive the spindle motor 404 so as to record the video data and the audio data onto the optical disc 40. After that, the controller 450 causes the laser control portion 494 to control the optical pickup 410 to emit laser. Then, the controller 450 causes a focus control portion 422 and a focus drive portion 432 to perform the focus servo so as to shift a beam spot to a prescribed recording position on the optical disc 40.

Specifically, a focus error signal is supplied to the focus control portion 422, and the focus control portion 422 directs the focus drive portion 432 to generate a focus drive signal having a designated gain with respect to the supplied focus error signal. Then, the focus drive portion 432 generates the focus drive signal based on control by the focus control portion 422, and the optical pickup 410 adjusts the position of a beam spot based on the focus drive signal generated by the focus drive portion 432.

After that, the controller 450 causes the sled servo portion 458 to drive the sled motor 454 so as to move the optical pickup 410 in the radial direction of the optical disc 40. In FIG. 2, the controller 450 is indicated by the symbol C surrounded by a circle in some portions for the sake of clearness of the drawing.

After the beam spot reaches the prescribed recording position, the tracking control portion 424 and the tracking drive portion 434 perform the tracking servo, so that the beam spot traces the track of the optical disc 40. Then, the laser control portion 494 controls the laser emitted from the optical pickup 410 to write the video data and the audio data that are transferred from the memory 470 to the recording track of the optical disc 40.

Following the writing of the video data and the audio data to the optical disc 40, a servo error signal is read out from the optical disc 40 and supplied to the signal detection portion 414. The servo error signal is then supplied from the signal detection portion 414 to the control portion 420, and thereby the focus servo control and the tracking servo control by the optical pickup 410 are performed.

The speed of writing data from the memory 470 to the optical disc 40 is higher than the speed of transferring data from the recording signal processing portion 492 to the memory 470. Thus, the amount of data stored in the memory 470 decreases as the data is written to the optical disc 40. If the amount of stored data becomes equal to or smaller than a prescribed amount, the controller 450 causes the laser control portion 494 to interrupt data writing to the optical disc 40. Further, the controller 450 turns off the focus servo and the tracking servo, turns off the laser and stops the operation of the optical pickup 410 in order to reduce power consumption.

Then, the video data and the audio data are continuously acquired by the image pickup device 486 and the microphone 490, and if the amount of data stored in the memory 470 becomes larger than the prescribed amount, the controller 450 starts the operation of the optical pickup 410, so that the above-described data writing to the optical disc 40 is resumed. Thus, in the optical disc apparatus 21 according to the related art, the above-described data recording onto the optical disc 40 is performed intermittently in the recording mode.

### (Operation in the Playback Mode)

In the playback mode, on the other hand, the video data and the audio data recorded on the optical disc 40 are read out through the optical pickup 410. The data read out through the optical pickup 410 is processed by the equalizer 462 and the binarization portion 466 and then stored into the memory 470. Then, the video data and the audio data stored in the memory 470 are supplied to the playback signal processing portion 474 by the controller 450.

The playback signal processing portion 474 converts the format of the video data and the audio data supplied from the memory 470 into a format for playback and supplies the converted data to the audio output portion 478 and the display portion 27. The servo error signal that is detected by the optical pickup 410 at the time of reading the video data and the audio data is supplied to the control portion 420 through the signal detection portion 414, so that the control portion 420 and the drive portion 430 implement the focus servo control and the tracking servo control by the optical pickup 410.

In the playback mode, the speed of transferring data from the optical disc 40 to the memory 470 is higher than the speed of transferring data from the memory 470 to the display portion 27 and the audio output portion 478. Thus, the amount of data stored in the memory 470 increases as the data is read out from the optical disc 40. If the amount of stored data becomes equal to or larger than a prescribed amount, the controller 450 interrupts data reading from the optical disc 40 and stops the operation of the optical pickup 410. The playback is continuously performed, and if the amount of data stored in the memory 470 becomes smaller than the prescribed amount, the controller 450 starts the operation of the optical pickup 410, so that the above-described data reading from the optical disc 40 is resumed. Thus, in the optical disc apparatus 21 according to the related art, the above-described data reading from the optical disc 40 is performed intermittently in the playback mode.

As described in the foregoing, in the optical disc apparatus 21, the video data and the audio data are intermittently recorded onto the optical disc 40 by the optical pickup 410 while the video data and the audio data are continuously acquired in the recording mode. Therefore, the start of the focus servo and the tracking servo that follows the start of the operation of the optical pickup 410 and the stop of the focus servo and the tracking servo that follows the stop of the operation of the optical pickup 410 are repeated frequently. Thus, the focus servo and the tracking servo are switched on and off frequently in the recording mode in the optical disc apparatus 21 according to the related art.

### (Issue of the Optical Disc Apparatus 21 According to the Related Art)

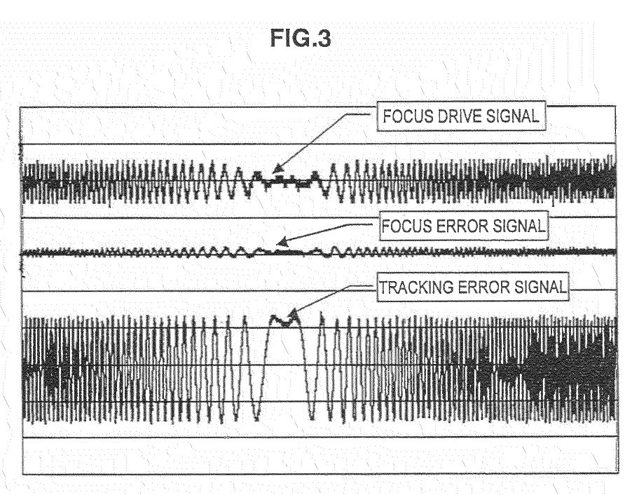

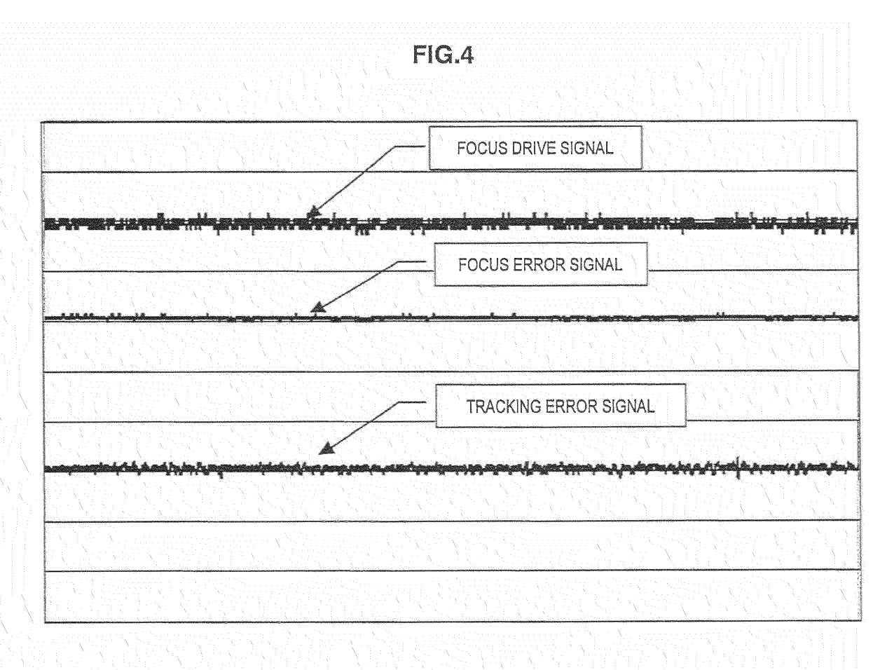

However, in the optical disc apparatus 21 according to the related art, during a first period from the start of the focus servo until the start of the tracking servo, the operation sound of the optical pickup 410 is picked up by the microphone 490 and recorded onto the optical disc 40 together with the audio data. Such an issue is described hereinafter with reference to FIGS. 3 and 4.

FIG. 3 is an explanatory view showing the relationship among the focus drive signal, the focus error signal and the tracking error signal during the first period. As shown in FIG. 3, in addition to a signal indicating the remaining bit of the servo in the focus direction which is an essential component of the focus error signal, the tracking error signal leaks into the focus error signal due to an optical factor. Thus, during the first period from the start of the focus servo until the start of the tracking servo when the amplitude of the tracking error signal is large, the amount of leakage of the tracking error signal into the focus error signal is large.

The focus drive portion 432 generates the focus drive signal in response to the above-described leakage signal also based on control by the focus control portion 422, and thereby the amplitude of the focus drive signal becomes undesirably large as shown in FIG. 3. Because an actuator for adjusting the beam spot position of the optical pickup 410 operates based on the focus drive signal, the level of the operation sound of the actuator increases as the amplitude of the focus drive signal becomes larger. Consequently, the operation sound of the actuator is picked up by the microphone 490 and recorded onto the optical disc 40.

On the other hand, during a second period when the focus servo is performed and the tracking servo is also performed, the issue of the operation sound of the actuator is improved as shown in FIG. 4.

FIG. 4 is an explanatory view showing the relationship among the focus drive signal, the focus error signal and the tracking error signal during the second period. As shown in FIG. 4, after the tracking servo is started, the amplitude of the tracking error signal becomes small, and therefore the leakage of the tracking error signal into the focus error signal decreases. Consequently, the amplitude of the focus drive signal generated by the focus drive portion 432 becomes small, and the above-described operation sound of the actuator becomes almost negligible.

Because the above-described leakage of the tracking error signal into the focus error signal during the first period occurs optically, it is difficult to completely remove it.

On the other hand, if a distance between the optical pickup 410 including the actuator that generates the operation sound and the microphone 490 is sufficiently large, it is possible to reduce the operation sound to be picked up by the microphone 490. However, because the optical disc apparatus 21, which is portable imaging equipment, today confronts the demand for size reduction for better portability and operability and thus the components are contained in a limited housing space, it is difficult to place the optical pickup 410 and the microphone 490 sufficiently distant from each other. Although there is an alternative method that places a sound insulator for preventing the operation sound from entering the microphone 490, this increases the entire size of the optical disc apparatus 21.

Another alternative method for reducing the operation sound in the first period is that the focus control portion 422 controls the focus drive portion 432 to generate the focus drive signal with a previously set gain that is lower than a gain in the second period.

However, because the level of the operation sound recorded onto the optical disc 40 is affected by a distance between the microphone 490 and the optical pickup 410, the characteristics of the optical pickup 410, a variation in the chucking of the optical disc 40 and so on, it is difficult to previously set the gain of the focus drive signal with respect to the focus error signal to an appropriate value. Further, excessive reduction of the gain of the focus drive signal with respect to the focus error signal causes degradation in the stability of the focus servo.

Given such circumstances, the optical disc apparatus 20 according to an embodiment has been invented. According to the optical disc apparatus 20 of the embodiment, it is possible to dynamically set the gain of the focus drive signal so that the operation sound of the optical pickup stays equal to or lower than a prescribed level. The optical disc apparatus 20 is described hereinafter in detail with reference to FIGS. 5 to 9.

### (3) Functions of the Optical Disc Apparatus According to an Embodiment

FIG. 5 is a block diagram showing the configuration of the optical disc apparatus 20 according to an embodiment. Referring to FIG. 5, the optical disc apparatus 20 according to the embodiment includes a spindle motor 204, a spindle servo portion 208, an optical pickup 210, a signal detection portion 214, a control portion 220, a drive portion 230, an address decoder circuit 240, a controller 250, a sled motor 254, a sled servo portion 258, an equalizer 262, a binarization portion 266, a memory 270, a playback signal processing portion 274, an audio output portion 278, an operating portion 282, an image pickup device 286, a microphone 288, a recording signal processing portion 290, a laser control portion 292, an operation sound extraction portion 294, a focus gain holding portion 296, a focus gain setting portion 298, and a display portion 26.

The spindle motor 204 drives the rotation of the optical disc 40 attached thereto based on a control signal input from the spindle servo portion 208. The optical disc 40 may be CD-R (Compact Disc Recordable)/RW (ReWritable), DVD-R (Digital Versatile Disc Recordable)/RW/+R/+RW/RAM (Random Access Memory), BD (Blu-ray Disc (registered trademark))-R/BD-RE, and so on.

The data recorded on the optical disc 40 may be music data such as music, a lecture and a radio program, video data such as a movie, a television program, a video program, a photograph, a document, a picture and a chart, given data such as a game and software, and so on.

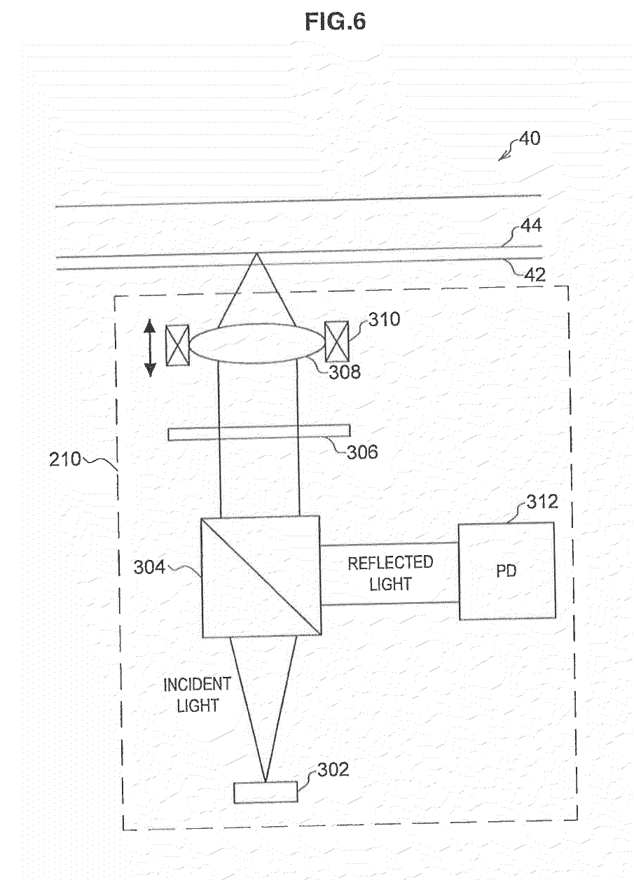

The optical pickup 210 applies laser light to the optical disc 40, converts the reflected light from the optical disc 40 into an electrical signal and outputs it. The configuration of the optical pickup 210 is described in detail hereinafter with reference to FIG. 6.

FIG. 6 is an explanatory view showing the configuration of the optical pickup 210. Referring to FIG. 6, the optical pickup 210 includes a LD (Laser Diode) 302, a PBS (Polarizing Beam Splitter) 304, a ¼ wave plate 306, an objective lens 308, a two-axis actuator 310, and a PD (Photodiode) 312.

The LD 302 emits laser light having a wavelength corresponding to the kind of the optical disc 40 based on control by the laser control portion 292. The PBS 304 transmits the component of the laser light emitted from the LD 302 which oscillates in one direction and reflects the component of the laser light which oscillates in the other directions. The ¼ wave plate 306 converts linearly polarized light into circularly polarized light and converts circularly polarized light into linearly polarized light. The objective lens 308 condenses the laser light emitted from the LD 302 and transmitted through the PBS 304 and the ¼ wave plate 306 and forms a beam spot on a recording layer 44 of the optical disc 40.

The two-axis actuator 310 moves the objective lens 308 in the direction away from the optical disc 40 based on the focus drive signal generated by the focus drive portion 232. Thus, the two-axis actuator 310 has a function as a focus adjustment portion that adjusts the position of a beam spot. Further, the two-axis actuator 310 moves the objective lens 308 in the radial direction of the optical disc 40 based on the tracking drive signal generated by the tracking drive portion 234.

The PD 312 has a function as a photoelectric conversion portion to which the reflected light from a surface layer 42, the recording layer 44 or the like of the optical disc 40 is incident through the objective lens 308, the ¼ wave plate 306 and the PBS 304 and which converts the incident reflected light into an electrical signal.

Referring back to FIG. 5 showing the configuration of the optical disc apparatus 20, the signal detection portion 214 detects signals such as a focus error signal, a tracking error signal and a data signal from the electrical signal input from the PD 312 of the optical pickup 210.

The control portion 220 includes the focus control portion 222 and the tracking control portion 224 to control the focus servo and the tracking servo by the optical pickup 210. Specifically, the focus control portion 222 directs the focus drive portion 232 to generate a focus drive signal having a designated gain (focus gain) with respect to the focus error signal detected by the signal detection portion 214. In this embodiment, a method of setting the gain of the focus drive signal with respect to the focus error signal during the first period when the focus servo is performed and the tracking servo is not performed is important as described later. The tracking control portion 224 directs the tracking drive portion 234 to generate a tracking drive signal corresponding to the tracking error signal detected by the signal detection portion 214.

The drive portion 230 has a function as a signal generation portion that includes the focus drive portion 232 and the tracking drive portion 234 to generate drive signals directed by the control portion 220. Specifically, the focus drive portion 232 generates a focus drive signal directed by the focus control portion 222, and the tracking drive portion 234 generates a tracking drive signal directed by the tracking control portion 224. The two-axis actuator 310 in the optical pickup 210 moves the objective lens 308 based on the focus drive signal and the tracking drive signal generated in the drive portion 230 and thereby implements the focus servo and the tracking servo.

The address decoder circuit 240 receives address information that is previously recorded by wobbling the track on the optical disc 40 as a tracking signal (PP signal), decodes the address information and supplies it to the controller 250.

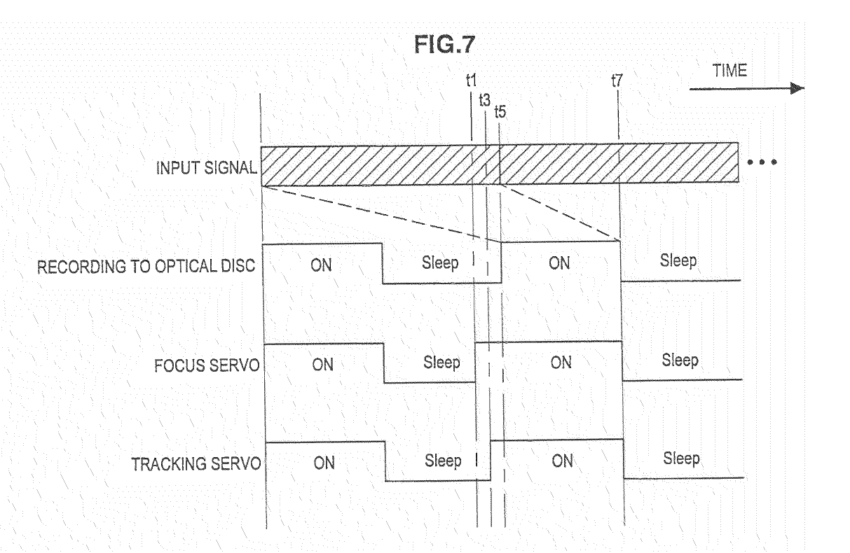

The controller 250 controls the sled servo portion 258, for example, so as to move the optical pickup 210 to a desired position based on the address information supplied from the address decoder circuit 240. Further, the controller 250 controls the laser control portion 292, the focus control portion 222 and the tracking control portion 224 to sequentially switch on and off the laser light application, the focus servo and the tracing servo as described later with reference to FIG. 7.

The equalizer 262 performs waveform shaping of a data signal (RF signal) such as videos and sounds that is read by the optical pickup 210, and the binarization portion 266 converts the waveform-shaped data signal into a digital format and supplies it as video data and audio data to the memory 270.

The playback signal processing portion 274 performs EFM-Plus demodulation, error correction, decoding or the like on the video data and the audio data stored in the memory 270 and then supplies the video data to the display portion 26 and the audio data to the audio output portion 278. The display portion 26 displays a video based on the video data supplied from the playback signal processing portion 274, and the audio output portion 278 such as earphones and a speaker outputs a sound based on the audio data supplied from the playback signal processing portion 274.

The operating portion 282 corresponds to user interfaces such as the recording button 34 and the playback button 36 shown in FIG. 1 and detects various kinds of instructions from a user. Examples of the instructions are playback, pause, fast-forwarding, fast-rewinding, volume control and so on of video data and audio data.

The image pickup device 286 converts the video of a subject whose light is collected by the lens portion 22 into video data, which is an electrical signal. For example, the image pickup device 286 may be a CMOS image pickup device, a LBCAST image pickup device, a CCD (Charge Coupled Device) or the like. The microphone 288 has a function as a sound pickup portion that converts a sound emitted from the surroundings into audio data, which is an electrical signal. The recording signal processing portion 290 converts the video data of the subject image captured by the image pickup device 286 and the audio data of the external sound captured by the microphone 288 into a format for recording onto the optical disc 40.

The operations of the optical disc apparatus 20 in the recording mode and the playback mode are described hereinbelow.

### (Operation in the Recording Mode)

In the optical disc apparatus 20, in the recording mode, the video data of the subject image captured by the image pickup device 286 and the audio data of the external sound captured by the microphone 288 are input to the recording signal processing portion 290. The recording signal processing portion 290 converts the input video data and audio data into data in a format recordable onto the optical disc 40. Then, the data converted by the recording signal processing portion 290 is temporarily stored in the memory 270. If the amount of data stored in the memory 270 becomes larger than a prescribed amount, the video data and the audio data are read out from the memory 270 by the controller 250 and transmitted to the laser control portion 292.

Further, the controller 250 causes the spindle servo portion 208 to drive the spindle motor 204 so as to record the video data and the audio data onto the optical disc 40. After that, the controller 250 causes the laser control portion 292 to control the optical pickup 210 to emit laser. Then, the controller 250 causes the focus control portion 222 and the focus drive portion 232 to perform the focus servo so as to shift a beam spot to a prescribed recording position on the optical disc 40.

After that, the controller 250 causes the sled servo portion 258 to drive the sled motor 254 so as to move the optical pickup 210 in the radial direction of the optical disc 40. In FIG. 5, the controller 250 is indicated by the symbol C surrounded by a circle in some portions for the sake of clearness of the drawing.

After the beam spot reaches the prescribed recording position, the tracking control portion 224 and the tracking drive portion 234 perform the tracking servo, so that the beam spot traces the track of the optical disc 40. Then, the laser control portion 292 modulates the laser light emitted from the optical pickup 210 to write the video data and the audio data that are transferred from the memory 270 to the recording track of the optical disc 40.

Following the writing of the video data and the audio data to the optical disc 40, a servo error signal is read out from the optical disc 40 and supplied to the signal detection portion 214. The servo error signal is then supplied from the signal detection portion 214 to the control portion 220, so that the focus servo control and the tracking servo control by the optical pickup 210 are performed.

The speed of writing data from the memory 270 to the optical disc 40 is higher than the speed of transferring data from the recording signal processing portion 290 to the memory 270. Thus, the amount of data stored in the memory 270 decreases as the data is written to the optical disc 40. If the amount of stored data becomes equal to or smaller than a prescribed amount, the controller 250 causes the laser control portion 292 to interrupt data writing to the optical disc 40. Further, the controller 250 turns off the focus servo and the tracking servo, turns off the laser and stops the operation of the optical pickup 210 in order to reduce power consumption.

Then, the video data and the audio data are continuously acquired by the image pickup device 286 and the microphone 288, and if the amount of data stored in the memory 270 becomes larger than the prescribed amount, the controller 250 starts the operation of the optical pickup 210, so that the above-described data writing to the optical disc 40 is resumed. Thus, in the optical disc apparatus 20 according to the embodiment, the above-described data recording onto the optical disc 40 is performed intermittently in the recording mode.

### (Operation in the Playback Mode)

In the playback mode, on the other hand, the video data and the audio data recorded on the optical disc 40 are read out through the optical pickup 210. The data read out through the optical pickup 210 is processed by the equalizer 262 and the binarization portion 266 and then stored into the memory 270. Then, the video data and the audio data stored in the memory 270 are supplied to the playback signal processing portion 274 by the controller 250.

The playback signal processing portion 274 converts the format of the video data and the audio data supplied from the memory 270 into a format for playback and supplies the converted data to the audio output portion 278 and the display portion 26. The servo error signal that is detected by the optical pickup 210 at the time of reading the video data and the audio data is supplied to the control portion 220 through the signal detection portion 214, and thereby the control portion 220 and the drive portion 230 implement the focus servo control and the tracking servo control by the optical pickup 210.

In the playback mode, the speed of transferring data from the optical disc 40 to the memory 270 is higher than the speed of transferring data from the memory 270 to the display portion 26 and the audio output portion 278. Thus, the amount of data stored in the memory 270 increases as the data is read out from the optical disc 40. If the amount of stored data becomes equal to or larger than a prescribed amount, the controller 250 interrupts data reading from the optical disc 40 and stops the operation of the optical pickup 210. The playback is continuously performed, and if the amount of data stored in the memory 270 becomes smaller than the prescribed amount, the controller 250 starts the operation of the optical pickup 210, so that the above-described data reading from the optical disc 40 is resumed. Thus, in the optical disc apparatus 20 according to the embodiment, the above-described data reading from the optical disc 40 is performed intermittently in the playback mode.

As described in the foregoing, in the optical disc apparatus 20 according to the embodiment, the video data and the audio data are intermittently recorded onto the optical disc 40 by the optical pickup 210 while the video data and the audio data are continuously acquired in the recording mode. Therefore, the start of the focus servo and the tracking servo that follows the start of the operation of the optical pickup 210 and the stop of the focus servo and the tracking servo that follows the stop of the operation of the optical pickup 210 are repeated frequently. Thus, the focus servo and the tracking servo are switched on and off frequently in the recording mode in the optical disc apparatus 20 according to the embodiment.

Further, the controller 250 starts the focus servo and then starts the tracking the servo, and starts the recording of video data and audio data by the optical pickup 210 in the state where the focus servo and the tracking servo are performed as shown in FIG. 7.

FIG. 7 is an explanatory view showing the state of each function at the start of recording video data and audio data. As shown in FIG. 7, the recording of an input signal that contains video data, audio data and so on onto the optical disc 40 is performed intermittently and started at the timing t5, for example.

The focus servo is started at the timing t1 prior to the recording onto the optical disc 40, and the tracking servo is started at the timing t3, which is after the timing t1. Then, at the timing t7, the recording onto the optical disc 40, the focus servo and the tracking servo are turned off.

In this description, the period after the focus servo is started until the tracking servo is started (t1 to t3) is referred to as a first period, and the period when the focus servo and the tracking servo are performed (t3 to t7) is referred to as a second period.

Referring back to FIG. 5, the functions of the operation sound extraction portion 294, the focus gain holding portion 296 and the focus gain setting portion 298 related to gain setting of the focus drive signal in the first period are described hereinafter.

The operation sound extraction portion 294 extracts the operation sound of the optical pickup 210 based on the focus drive signal, which is the operation sound of the two-axis actuator 310, from the sound picked up by the microphone 288 and outputs the extracted sound to the focus gain setting portion 298. Specifically, the operation sound extraction portion 294 extracts the component in the frequency range (e.g. 1000 Hz) of the operation sound of the two-axis actuator 310 from the sound picked up by the microphone 288 by means of a bandpass filter. The frequency range of the operation sound of the two-axis actuator 310 is identifiable because it is the same as or close to the frequency range of the focus drive signal. Alternatively, the operation sound extraction portion 294 may extract the component in the frequency range of the operation sound of the two-axis actuator 310 by means of fast Fourier transform.

In the case where a constant sound occurs in the vicinity of the optical disc apparatus 20, extraction of the component in the frequency range of the operation sound of the two-axis actuator 310 may not result in extraction of the operation sound of the two-axis actuator 310 only. Thus, the operation sound extraction portion 294 may obtain the operation sound during the first period in which the operation sound of the two-axis actuator 310 would occur by calculating a difference from the component in the frequency range of the operation sound of the two-axis actuator 310 that is extracted during the second period.

The focus gain holding portion 296 stores an initial gain value and a fixed gain value. The focus gain setting portion 298 has a function as a gain setting portion that outputs the fixed gain value to the focus control portion 222 during the second period when the focus servo and the tracking servo are performed. As a result, during the second period, the focus drive portion 232 outputs the focus drive signal generated by amplifying the focus error signal with the fixed gain value.

On the other hand, during the first period after the focus servo is started until the tracking servo is started, the focus gain setting portion 298 changes the initial gain value as needed based on the level of the operation sound extracted by the operation sound extraction portion 294 and outputs it to the focus control portion 222.

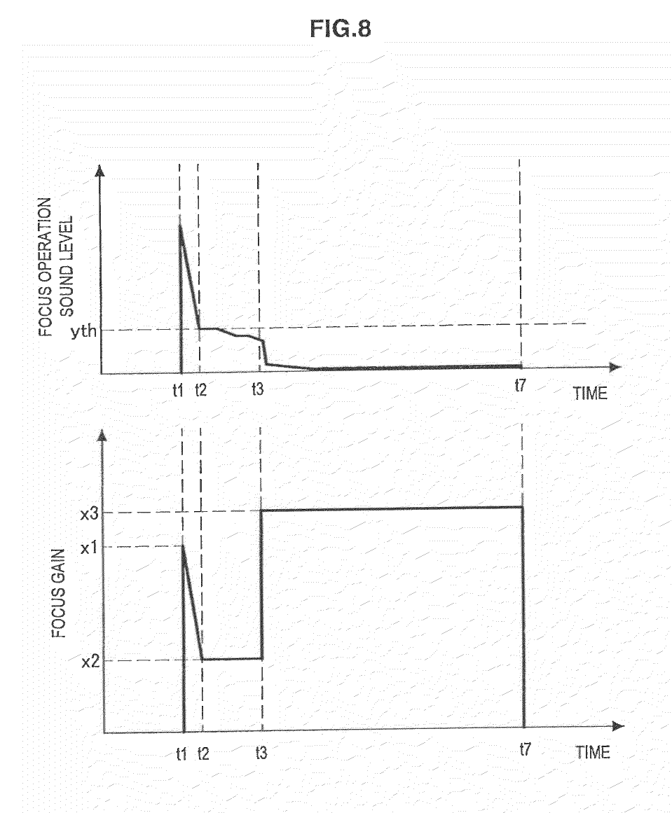

For example, the focus gain setting portion 298 may reduce the focus gain from the initial gain value until the operation sound level becomes equal to or lower than a prescribed value as shown in FIG. 8.

FIG. 8 is an explanatory view showing a change in focus gain during the first period. As shown in the lower part of FIG. 8, the focus gain setting portion 298 sets the focus gain at the timing t1, which is the start time point of the first period, to an initial gain value x1. However, because the operation sound level is higher than a prescribed value yth, the focus gain is reduced until the operation sound level becomes equal to or lower than the prescribed value yth.

At the timing t2, because the operation sound level becomes equal to or lower than the prescribed value yth, the focus gain setting portion 298 sets a focus gain x2 at the timing t2 as the gain value of the rest of the first period. Then, at the timing t3, which is the start time point of the second period, the focus gain setting portion 298 sets the focus gain to a fixed value x3. Although the fixed value x3 is larger than the focus gain x2, the operation sound is assumed not to become a problematic level because the tracking servo is performed.

FIG. 8 merely illustrates one example of a focus gain setting method by the focus gain setting portion 298, and the present invention is not limited thereto. For example, although the focus gain setting portion 298 sets the focus gain at the timing t2, which is the timing when the operation sound level becomes equal to or lower than the prescribed value yth, as the gain value of the rest of the first period in the above-described example, the focus gain setting portion 298 may dynamically set the focus gain so as to keep the operation sound level equal to or lower than the prescribed value yth until the end of the first period.

Further, although the focus gain setting portion 298 reduces the focus gain gradually from the initial gain value x1 to thereby reach the focus gain x2 in the above-described example, the focus gain setting portion 298 may specify the focus gain x2 with which the operation sound level becomes lower than the prescribed value yth by a different method. For example, the focus gain setting portion 298 may set the focus gain to half the value of the initial gain value x1. Then, if the operation sound level is equal to or lower than the prescribed value yth, the focus gain setting portion 298 may set the focus gain to a prescribed number of times the above value, and, if the operation sound level is equal to or higher than the prescribed value yth, the focus gain setting portion 298 may set the focus gain to further half the above value. Such a configuration shortens a time to reach the focus gain x2.

Alternatively, the focus gain setting portion 298 may hold a gain table in which the amount of decrease in focus gain is associated with the operation sound level and thereby select an optimum speed set value.

Although the focus gain x2 is smaller than the fixed gain value x3 during the second period in the above-described case, the focus gain x2 may be larger than the fixed gain value x3 if the operation sound level is equal to or lower than the prescribed value yth.

Further, a lower limit may be set to the focus gain, and the focus gain setting portion 298 may set the focus gain during the first period in the range that it does not falls below the lower limit. Such a configuration prevents significant degradation of the stability of the focus servo due to excessive reduction of the focus gain.

The focus gain setting portion 298 may change the gain of the focus drive signal according to the level of the operation sound only in the case where sound pickup by the microphone 288 is performed during the first period. Such a configuration prevents degradation of the stability of the focus servo due to unnecessary reduction of the gain of the focus drive signal while sound pickup by the microphone 288 is not performed.

### (4) Operation of the Optical Disc Apparatus According to an Embodiment

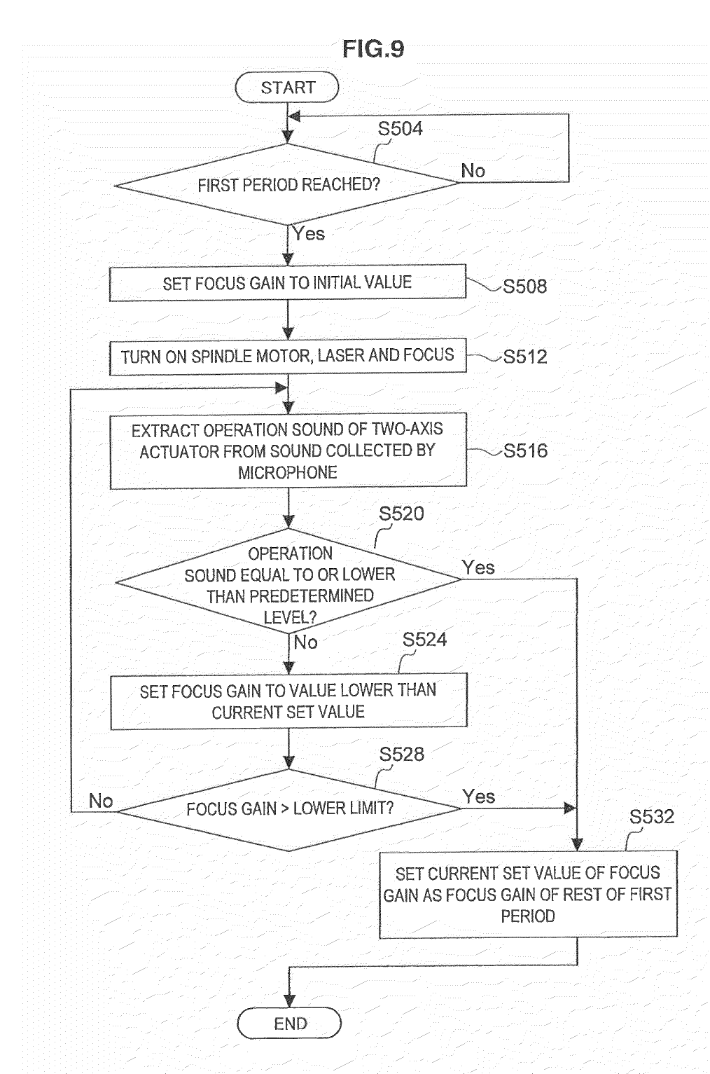

The configuration and the functions of the optical disc apparatus 20 according to the embodiment are described in the foregoing. In the following, a gain setting method executed in the optical disc apparatus 20 according to the embodiment is described with reference to FIG. 9.

FIG. 9 is a flowchart showing the flow of the gain setting method executed in the optical disc apparatus 20. Referring to FIG. 9, if the first period comes (S504), the focus gain setting portion 298 reads the initial gain value from the focus gain holding portion 296 and sets the initial gain value as the focus gain (S508). Next, the controller 250 makes control so as to start the operation of the spindle motor 204, the laser light application and the focus servo (S512).

Then, the operation sound extraction portion 294 extracts the operation sound of the two-axis actuator 310 from the sound picked up by the microphone 288 (S516). After that, the focus gain setting portion 298 determines whether the operation sound extracted by the operation sound extraction portion 294 is equal to or lower than a prescribed level (S520) and, if it is not equal to or lower than the prescribed level, sets the focus gain to a value lower than the current set value (S524). Further, the focus gain setting portion 298 determines whether the focus gain reaches a lower limit (S528), and if it does not reach the lower limit, the processing from S516 is repeated.

If, on the other hand, the focus gain setting portion 298 determines in S520 that the operation sound extracted by the operation sound extraction portion 294 is equal to or lower than the prescribed level, or it determines in S528 that the focus gain reaches the lower limit, the focus gain setting portion 298 sets the current set value of the focus gain as the focus gain of the rest of the first period (S532).

### (5) SUMMARY

As described in the foregoing, in the optical disc apparatus 20 according to the embodiment, the focus gain setting portion 298 changes the gain of the focus drive signal during the first period according to the actual operation sound level of the two-axis actuator 310 that is extracted by the operation sound extraction portion 294. The optical disc apparatus 20 can thereby set the gain of the focus drive signal during the first period not previously but dynamically according to the actual operation sound level of the two-axis actuator 310.

Further, the focus gain setting portion 298 sets the gain of the focus drive signal during the first period so that the operation sound becomes equal to or lower than a prescribed level. It is thereby possible to limit the level of the operation sound recorded onto the optical disc 40 to be equal to or lower than a prescribed level.

It should be understood by those skilled in the art that various modifications, combinations, sub-combinations and alterations may occur depending on design requirements and other factors insofar as they are within the scope of the appended claims or the equivalents thereof.

For example, it is not necessary to perform each step in the processing of the optical disc apparatus 20 in chronological order according to the sequence shown in the flowchart. For example, each step in the processing of the optical disc apparatus 20 may include the processing that is executed in parallel or individually (e.g. parallel processing or object processing). It is possible to create a computer program that causes the hardware such as CPU, ROM or RAM that are included in the optical disc apparatus 20 to perform the equal function to each component of the optical disc apparatus 20 described above. Further, a storage medium that stores such a computer program may be provided. Furthermore, each functional block that is shown in the functional block diagram of FIG. 5 may be implemented by hardware, thereby achieving the series of processing on hardware.

What is claimed is:

1. An optical disc apparatus comprising:
a sound pickup portion;
an optical pickup to record a sound picked up by the sound pickup portion as audio data onto an optical disc using laser light;
a signal generation portion to generate a focus drive signal having a designated gain with respect to a focus error signal;
a focus adjustment portion to adjust a focal position of the laser light based on the focus drive signal generated by the signal generation portion;
a tracking control portion to control tracking so that the optical pickup traces a track formed on the optical disc;
an operation sound extraction portion to extract an operation sound of the focus adjustment portion from the sound picked up by the sound pickup portion; and
a gain setting portion to change the gain of the focus drive signal during a first period when adjustment of the focal position of the laser light by the focus adjustment portion is performed and control by the tracking control portion is not performed according to a level of the operation sound extracted by the operation sound extraction portion.

2. The optical disc apparatus according to claim 1, wherein
the gain setting portion sets the gain of the focus drive signal during the first period to a gain lower than a gain during a second period when adjustment of the focal position of the laser light by the focus adjustment portion is performed and control by the tracking control portion is performed.

3. The optical disc apparatus according to claim 2, wherein
the gain setting portion sets the gain of the focus drive signal during the first period to a gain causing the operation sound to become equal to or lower than a prescribed level.

4. The optical disc apparatus according to claim 3, wherein
the gain setting portion reduces the gain of the focus drive signal during the first period until the operation sound becomes equal to or lower than a prescribed level.

5. The optical disc apparatus according to claim 1, wherein
the gain setting portion changes the gain of the focus drive signal according to the level of the operation sound only when sound pickup by the sound pickup portion is performed during the first period.

6. The optical disc apparatus according to claim 1, further comprising:
a memory to temporarily store the sound picked up by the sound pickup portion as audio data, wherein
the optical pickup intermittently records the audio data temporarily stored in the memory onto the optical disc using the laser light, and
control by the tracking control portion is started after adjustment of the focal position of the laser light by the focus adjustment portion is started, and recording of the audio data onto the optical disc by the optical pickup is started after control by the tracking control portion is started.

7. A program causing a computer installed in an optical disc apparatus including a sound pickup portion, an optical pickup to record a sound picked up by the sound pickup portion as audio data onto an optical disc using laser light, a signal generation portion to generate a focus drive signal having a designated gain with respect to a focus error signal, a focus adjustment portion to adjust a focal position of the laser light based on the focus drive signal generated by the signal generation portion, and a tracking control portion to control tracking so that the optical pickup traces a track formed on the optical disc to implement functions comprising:
an operation sound extraction portion to extract an operation sound of the focus adjustment portion from the sound picked up by the sound pickup portion; and
a gain setting portion to change the gain of the focus drive signal during a first period when adjustment of the focal position of the laser light by the focus adjustment portion is performed and control by the tracking control portion is not performed according to a level of the operation sound extracted by the operation sound extraction portion.

8. A gain setting method executed in an optical disc apparatus including a sound pickup portion, an optical pickup to record a sound picked up by the sound pickup portion as audio data onto an optical disc using laser light, a signal generation portion to generate a focus drive signal having a designated gain with respect to a focus error signal, a focus adjustment portion to adjust a focal position of the laser light based on the focus drive signal generated by the signal generation portion, and a tracking control portion to control tracking so that the optical pickup traces a track formed on the optical disc, the method comprising the steps of:
extracting an operation sound of the focus adjustment portion from the sound picked up by the sound pickup portion; and
changing the gain of the focus drive signal during a first period when adjustment of the focal position of the laser light by the focus adjustment portion is performed and control by the tracking control portion is not performed according to a level of the operation sound.
